(19) United States
(12) Patent Application Publication
(10) Pub. No.: US 2007/0053133 A1
(43) Pub. Date: Mar. 8, 2007

(54) Using voltage feed forward to control a solenoid valve

(76) Inventor: Howard B. Evans, Sugar Hill, GA (US)

Correspondence Address: WOOD, HERRON & EVANS, LLP (NORDSON), 2700 CAREW TOWER, 441 VINE STREET, CINCINNATI, OH, 45202, US

(21) Appl. No.: 11/221,220

(22) Filed: Sep. 7, 2005

(51) Int. Cl. H01H 47/00

(52) U.S. Cl. 361/160

(57) ABSTRACT

An electric fluid dispenser for dispensing a fluid onto a substrate. A power switching circuit is connected to an unregulated rectified voltage. A solenoid connected to the power switching circuit operates a dispensing valve to move between open and closed positions. A driver circuit has a voltage compensator that integrates the unregulated rectified voltage over successive periods and pulse width modulates the power switching circuit in response to integrated voltage values during each successive period exceeding a voltage reference. Thus, the solenoid causes the dispensing valve to move between the open and closed positions substantially independent of variations in the unregulated rectified voltage.

### FIELD OF THE INVENTION

The present invention relates generally to fluid dispensing systems for dispensing flyable material, such as adhesives, sealants, caulks and the like, onto a substrate and, more particularly, to a driver circuit for controlling an operation of a solenoid-actuated valve within an electric dispensing gun.

### BACKGROUND OF THE INVENTION

Electric fluid dispensers have been developed for dispensing applications requiring a precise placement of a fluid, for example, an adhesive, onto a moving substrate, for example, packaging or a woven product. Dispensing guns of this type include a liquid passage that communicates between a pressurized adhesive supply and a valve mechanism provided at the end of the liquid passage. The valve mechanism is typically a movable valve stem positioned to selectively obstruct a dispensing orifice formed in a valve seat. The valve stem is extended and retracted relative to the valve seat in a controlled manner by a solenoid for providing repeatable and accurate dispense patterns of the liquid onto the moving substrate. Generally, the solenoid comprises an electromagnetic coil surrounding an armature that is energized to produce an electromagnetic field with respect to a magnetic pole, thereby moving the valve stem. More specifically, the forces of magnetic attraction between the armature and the magnetic pole move the armature and valve stem toward the pole, thereby opening the dispensing valve. At the end of a dispensing cycle, the electromagnet is de-energized, and a return spring returns the armature and valve stem to their original positions, thereby closing the dispensing valve. One example of such a dispensing system is set forth in U.S. Pat. No. 5,812,355, which is owned by the assignee of the present invention and the disclosure of which is hereby incorporated in its entirety herein by reference.

Dispensing systems have been developed that employ driver circuits to control the operation of the solenoid within the dispensing gun in accordance with the current waveform 200 shown in FIG. 3B. To open a dispensing valve and thus, turn on the dispensing gun, a driver circuit applies an initial pull-in current magnitude I_{PK} to a solenoid coil at a rate indicated by a slope 208. The fast, initial pull-in current quickly retracts the valve stem and opens the dispensing valve at the beginning of a dispensing cycle. During a peak current period T_{PK}, the current is maintained at its desired peak current value I_{PK}. Thereafter, the gun driver supplies a hold current I_{H} necessary to hold the dispensing valve open by overcoming the opposing force of a return spring. That coil hold current, 204 of FIG. 3B, is maintained for the remaining period of the dispensing cycle on-time Tₒₙ. To close the dispensing valve and turn the dispensing gun off, current to the solenoid coil is reduced to zero or a minimal valve; and current induced in the coil from the collapsing inductive field is dissipated. A return spring moves an armature and valve stem in an opposite direction to close the dispensing valve and turn off the dispensing gun. A zero or minimal current is then maintained for an off time during the remaining time of the current waveform period.

While such a gun driver performs well, there is one condition which impairs its performance. The gun driver is designed to provide a desired opening time of the dispensing valve for a given line supply voltage, for example, 240 V_{AC}. The rate of current flow through the solenoid coil is a function of the power supply voltage and the coil inductance. Further, by design, the slope 208 provides a current flow to the solenoid coil so that the dispensing gun opens at a desired speed, or within a desired time duration, to dispense adhesive onto the substrate at a desired location. However, in many applications, the line voltage is simply rectified and therefor, includes a ripple voltage that is continuously changing. Further in many environments, the magnitude of the line voltage varies, thereby adversely affecting the actuation time of the dispensing valve. If, for example, the line voltage rises to 300 V_{AC}, the solenoid coil current increases at a rate represented by the steeper slope 210 shown dashed in FIG. 3B. Thus, the dispensing valve opens more quickly than with a line voltage of 240 V_{AC}.

Uncontrolled and unpredictable variations in the actuation time of the dispensing gun adversely impact the adhesive deposition process. Voltage variations changing the actuation time of the dispensing gun also change the starting and stopping locations of the dispensed adhesive on the substrate. If adhesive is to be dispensed on a package flap moving past the dispensing gun, an increase in line voltage causing the gun to switch-on or open faster than expected may cause adhesive to be dispensed too soon. Opening the gun too soon may cause adhesive to be dispensed prior to a leading edge of the flap reaching the dispensing location.

Similarly, a decrease in line voltage, for example, to 200 V_{AC} produces a slower rate of initial current flow, which would be represented by a slope less steep than the slope 208. Thus, a reduction in the voltage causes the gun to switch-off or close slower than expected. This slower gun operation may cause adhesive to continue to be dispensed after a trailing edge of the flap passes the dispensing location. Any unpredicted dispensing of adhesive onto a surface not intended to receive adhesive, potentially results in a scrap product. In addition, spurious adhesive spray that misses the substrate may lead to additional, time consuming, labor intensive and expensive cleaning and maintenance of equipment and areas adjacent the adhesive dispensing gun. Thus, such voltage variations may result in a less efficient, less economical and/or lower quality fluid dispensing operation.

It is known to use a regulated gun driver, that is, a gun driver with a regulated power supply. A regulated gun driver provides a constant voltage to the coil independent of the voltage variations to the power switching circuit. Thus, with respect to voltage variations, the use of a regulated gun driver provides a more consistent dispensing gun performance. However, regulated gun drivers are more expensive than gun drivers having an unregulated power supply and create more heat which requires more cooling and thus, further adds to their cost.

Therefore, there is a need to provide an electric fluid dispenser that uses a solenoid gun driver with an unregulated power supply that is insensitive to variations in the voltage applied to the solenoid coil.

### SUMMARY OF INVENTION

The present invention provides a gun driver with an unregulated power supply for a fluid dispenser that has an improved performance. The gun driver of the present invention executes a stable, consistent and high quality fluid dispensing process independent of line voltage variations. Further, the gun driver of the present invention has the advantages of being less expensive, operating more efficiently with less power loss and requiring less cooling than a gun driver having a regulated power supply. In addition, the gun driver of the present invention can be readily added to many existing gun driver circuits. Thus, the gun driver of the present invention is especially advantageous in those applications where better performance is required at a lesser cost.

In accordance with the principles of the present invention and the described embodiments, the invention in one embodiment provides a driver circuit for an electrically operated fluid dispenser dispensing a fluid onto a substrate. The fluid dispenser has a dispensing valve and a solenoid coil operative to cause the dispensing valve to move between open and closed positions. A power source provides an unregulated rectified voltage, and a power switching circuit is connected to the power source and the solenoid coil and is operable to supply current to the solenoid coil. A waveform generator produces a stepped waveform comprising an initial peak current portion followed by a lesser hold current portion, and the initial peak current portion has an initial rate of current flow represented by a slope of a leading edge of the initial peak current portion. A power switch control operates the power switching circuit in response to at least the stepped waveform. A voltage compensator is connected to the power source and the power switch control and has a pulse generator providing a plurality of pulses over successive periods. An integrator has an input responsive to the unregulated rectified voltage and is operable to provide a plurality of independent integrated voltage values over the successive periods. The integrator is reset in response to each of the pulses. A comparator provides a comparator output to the power switch control in response to each of the independent integrated voltage values exceeding a reference voltage. The comparator output controls an operation of the power switch control to maintain the leading edge of the initial peak current portion substantially constant and independent of variations in the unregulated rectified voltage.

In one aspect of this invention, the integrator is a voltage controlled current source connected to the unregulated rectified voltage and a capacitor chargeable by the current source. The current source is a resistor, and a time constant of a series circuit of the resistor and the capacitor is more than one order of magnitude greater than a time duration of each of the successive periods.

In another embodiment, the invention provides a method of integrating the unregulated rectified voltage over successive periods of time to provide an integrated voltage value. Then, the integrated voltage value is compared to a reference voltage; and during each successive period of time, the power switching circuit is operated to terminate the supply of current to the solenoid coil in response to the integrated voltage value being greater than the reference voltage. Thus, the leading edge of the initial peak current portion is maintained substantially constant and independent of variations in the unregulated rectified voltage.

Various additional advantages, objects and features of the invention will become more readily apparent to those of ordinary skill in the art upon consideration of the following detailed description of embodiments taken in conjunction with the accompanying drawings.

### BRIEF DESCRIPTION OF DRAWINGS

FIG. 1 is a schematic block diagram of a gun driver that may be used to operate a fluid dispenser in accordance with the principles of the present invention.

FIGS. 2A-2E are schematic diagrams of waveforms within the gun driver illustrated in FIG. 1.

FIG. 3A is a schematic diagram of a current waveform provided by the gun driver of FIG. 1.

FIG. 3B is a schematic diagram of a current waveform provided by a known driver circuit.

### DETAILED DESCRIPTION OF THE INVENTION

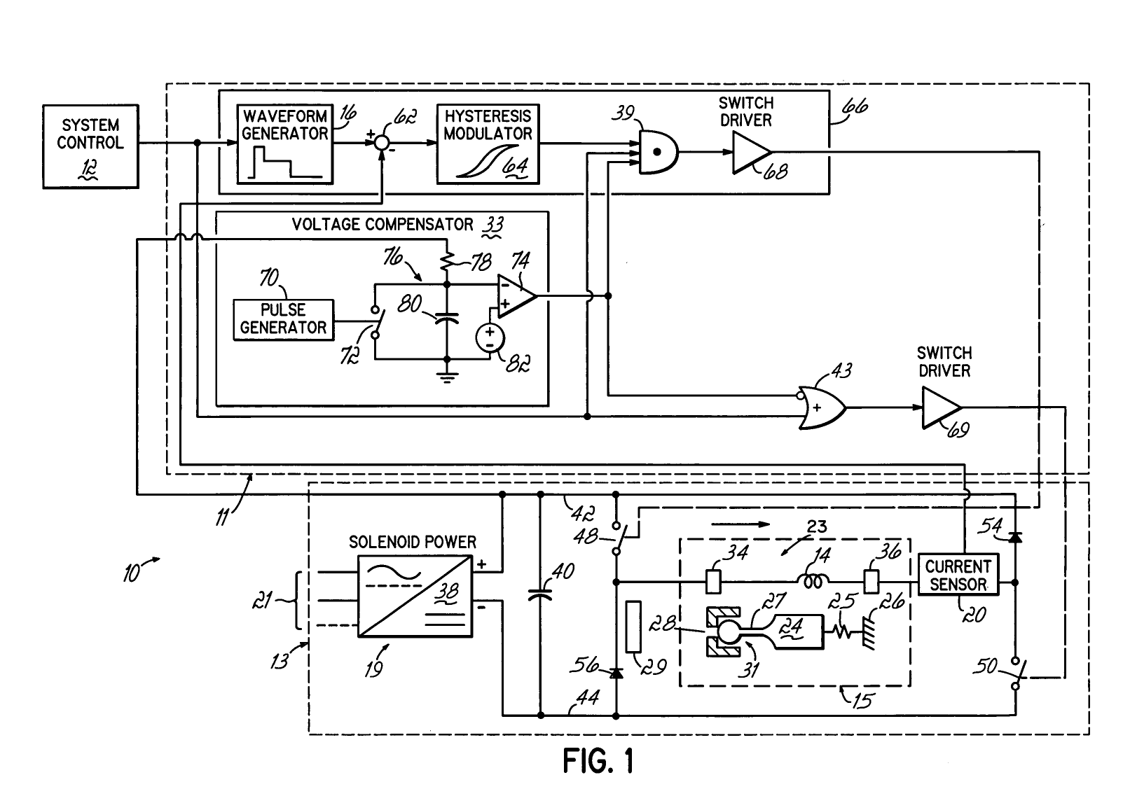

Referring to FIG. 1, an gun driver or controller 10 for an electric fluid dispensing gun 15 is used to dispense adhesive onto a substrate moving with respect to the gun. The gun driver 10 includes a control circuit 11 and a power circuit 13 for controlling operation of one or more electric dispensing guns of the type used to dispense adhesives, sealants, caulking and the like, represented diagrammatically at 15. The power circuit 13 includes an unregulated power supply 19 that is connected to a main or line voltage source 21. Electric guns are preferred because of the precision with which they may be controlled during a fluid dispensing operation. The control circuit 11 operates in response to signals from a system control 12 to provide a stepped waveform to the power circuit 13. The system control 12 includes all of the other known dispensing system or machine controls necessary for the operation of the dispensing system, for example, a pattern control. The system control 12 also includes input devices such as a keypad, pushbuttons, etc. and output devices such as a display, indicator lights, etc. that provide communication links with a user in a known manner.

The electric dispensing gun 15 includes a solenoid 23 having a coil 14 and a movable armature 24 to regulate the flow of liquid through the gun 15. The armature 24 is usually biased by a spring mechanism 25 that is connected between one end of the armature 24 and a fixed reference 26. The armature 24 is connected to a plunger or valve stem 27 that operatively cooperates with an orifice 28 to form a dispensing valve 31 within the electric dispensing gun 15. Retracting the armature 24 against the force of the spring mechanism 25 opens the dispensing valve 31, and pressurized adhesive flows through the orifice 28 onto a substrate 29. As is well known in the art, the armature 24 is actuated by application of current through the solenoid coil 14. The coil 14 has electrical properties modeled as a resistance in series with an inductance. The ends of the coil 14 terminate at first and second terminals 34, 36 that are selectively coupled to the power supply 19 as described in detail below.

The unregulated power supply 19 is connected to a source of power 21. The power supply 19 has an AC to DC converter 38 providing a rectified voltage with a ripple that is lowpass filtered by a capacitor 40 coupled across a positive voltage output 42 and a negative voltage output 44. The power supply outputs 42, 44 are connected to the first and second terminals 34, 36 of the solenoid 23 by first and second switches 48, 50, respectively, as described in detail below. The switches 48, 50 may be insulated gate bipolar transistors (IGBT), although equivalent switches are contemplated.

A forward current path through the solenoid coil 14 is generated when the first switch 48 is closed connecting the first terminal 34 to the positive output 42 and the second switch 50 is closed connecting the second terminal 36 to the negative output 44. A discharge current path through the solenoid coil 14 is generated when the first and second switches 48, 50 are open, thereby connecting the second terminal 36 to the positive output 42 via a diode 54 and connecting the first terminal 34 to the negative output 44 via a diode 56. With both switches 48, 50 open, the solenoid coil is clamped to, or short-circuited across, the power supply 19; and current rapidly flybacks to the supply 19. A current sensor 20 is coupled between the second terminal 36 and a junction of the second switch 50 with the diode 54. The current sensor 20 provides a current feedback to a summing node 62 in the control circuit 11 for closed loop control of the coil current. The current sensor 20 can be implemented with any one of many current measuring devices and methods, for example, a simple resistor, a Hall effect device, a current transformer, etc.

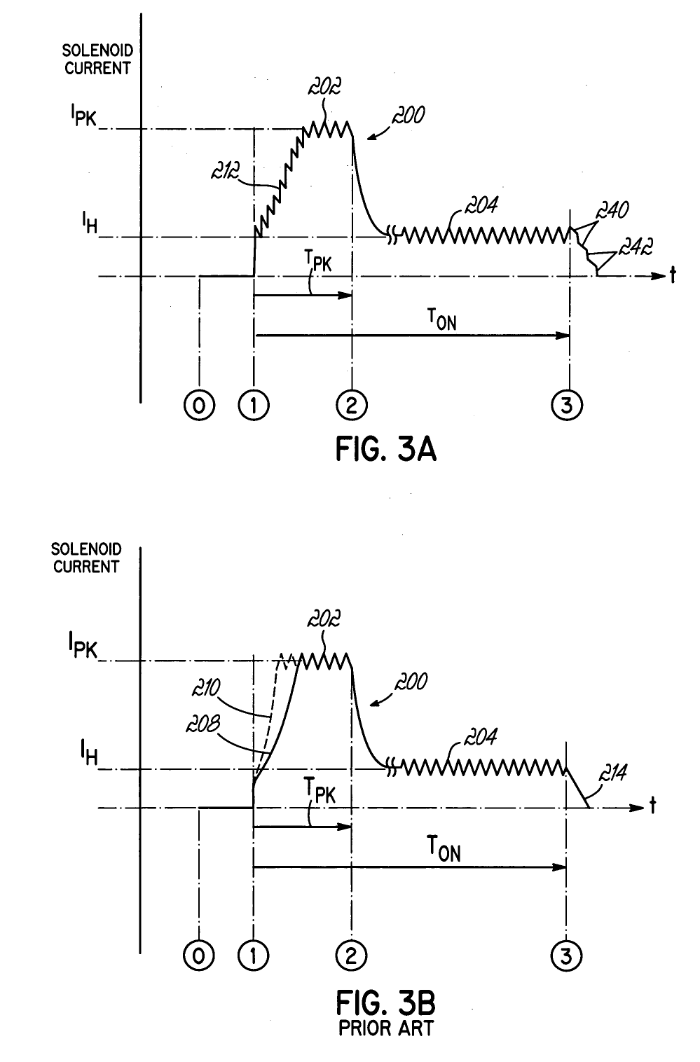

In one exemplary embodiment, assume the control circuit 11 is designed to operate with a line voltage of 240 V_{AC}. Referring to FIG. 3A, a State 0 is defined as a period between dispensing cycles during which the waveform generator 16 provides a current setpoint substantially equal to, or close to, zero. To turn the gun on and initiate State 1, the system control 12 switches a state of a trigger or gun ON/OFF signal. Assume for purposes of this embodiment that the gun ON/OFF signal is switched to a high state. The waveform generator 16 provides an output representing a peak current setpoint I_{PK}. A current sensor 20 is often used to provide a current feedback signal to a summing junction 62, so that the current in the coil 14 is maintained at the desired current setpoint provided by the waveform generator 16. The hysteresis modulator 64 functions similarly to a variable frequency PWM. Upon the gun ON/OFF signal going high, the summation node 62 compares the peak current setpoint to the current feedback from the current sensor 20 and generates an error signal that is used to drive the hysteresis modulator 64.

At the start of the on-time T_{ON}, the switch driver 69 holds the switch 50 closed; and in response to the current in the coil 14 being less than the peak current setpoint, the output of the modulator 64 commands the switch driver 66 to close the switch 48. In the absence of the voltage compensator 33, the switches 48, 50 provide a forward current path through the solenoid coil 14, and current in the coil 14 increases at a high rate as shown at 208 in FIG. 3B. Any changes in the line voltage source 21 or the rectified voltage 42 cause corresponding changes in the slope 208 in FIG. 3B, thereby changing the speed and actuation time at which the dispensing valve is opened.

To address that problem, the control circuit 11 further includes a voltage compensator 33 that functions to modify the operation of power switch 48, so that the current rise in the coil 14 represented by the slope 208 is substantially independent of a changes in the rectified voltage on line 42. The voltage compensator 33 functions to modulate the time or duration that the rectified voltage on line 42 is applied to the coil 14 as a function of the magnitude of the rectified voltage. As noted earlier, the rectified voltage has a continuous ripple that is often constantly changing; and in addition, any changes in the line voltage supply 21 cause the rectified voltage to change. If the rectified voltage increases, the voltage compensator 33 reduces the time that the increased voltage is applied to the coil 14. Similarly, if the rectified voltage drops, the voltage compensator 33 increases the time the reduced voltage is applied to the coil.

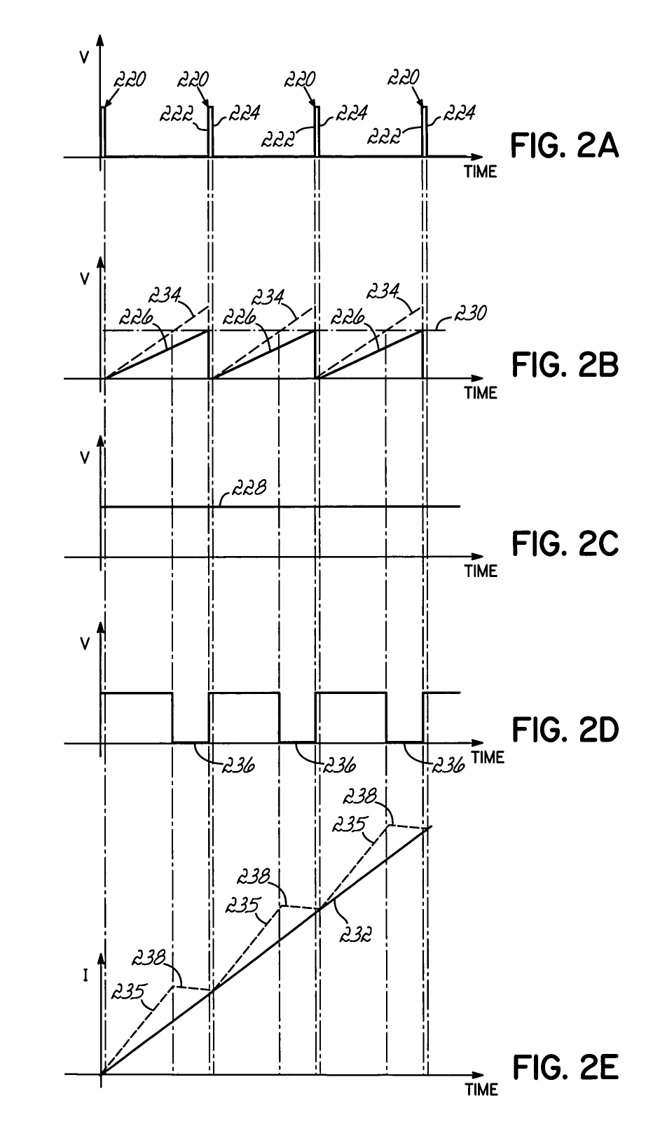

The voltage compensator 33 includes a pulse generator 70, a switch 72, a comparator 74, a reference voltage source 82 and an R-C circuit 76 having a resistor 78 and capacitor 80. The pulse generator 70 provides a series of pulses 220 as shown in FIG. 2A. With each leading pulse edge 222, the switch 72 is closed, thereby providing a conduction path to discharge the capacitor 80. With each trailing pulse edge 224, the switch 72 is opened; and the rectified voltage on line 42 charges capacitor 80 via resistor 78 as represented by a capacitor current ramp 226 in FIG. 2B. Thus, over the period T, the ramp 226 represents an integrated voltage value of the regulated rectified voltage.

The voltage compensator 33 has several design criteria. First, it is desirable to operate within a linear charging range of the capacitor 80; and therefore, the time constant of the R-C circuit 76 is chosen to be substantially larger than the period T between the pulses 220 from the pulse generator 70. Generally, the R-C circuit time constant is chosen to be one or more orders of magnitude greater than the period T. However, in some applications, an R-C time constant that is less than an order of magnitude greater than the period T may be chosen. By operating in the capacitor's linear charging range, the current ramp 226 is generally an analog of initial current flow in the solenoid coil 14. Second, the width of each of the pulses 220 is kept to a minimum duration required to allow the capacitor 80 to discharge. Third, the resistor 78 has a very large resistance value, so that it functions like a voltage-controlled current source. Further, the resistor 78 and capacitor 80 function as an integrator of the unregulated rectified voltage.

The reference voltage source 82 is adjusted to provide a reference voltage V_{REF} at 230 that corresponds to a chosen, minimum line or rectified voltage below which the voltage compensator 33 is not functional. For a given application, a nominal line voltage is known and a range of expected variations from that nominal line voltage is determined. Such a range is often determined by geographic location and past experience with the nominal line voltage. The minimum rectified voltage is chosen to be at the lower end of the range of expected line voltage variations. An initial value for the reference voltage can be determined by the product of the period T times the chosen, minimum rectified voltage value divided by the product of the value of the resistor 78 times the value of the capacitor 80. That provides a theoretical reference voltage that produces a current ramp 226 shown in solid in FIG. 2B having a slope that intersects the reference voltage substantially simultaneously with an occurrence of a leading pulse edge 222. The reference voltage source 82 can be adjusted until that relationship is achieved. Thus, in this example, with the minimum rectified voltage, practically speaking, the output of the comparator 74 and hence, the voltage compensator 33, maintains a substantially constant high state as shown at 228 in FIG. 2C; and for a coil current less than the peak current setpoint, current is supplied to the coil at a substantially constant rate of increase as shown by the solid line 232 of FIG. 2E, which is comparable to the slope 208 of FIG. 3B.

If the rectified voltage increases to a magnitude greater than the minimum rectified voltage, current will be supplied to the coil 14 at an increased rate represented by the dashed slopes 235 of FIG. 2E, which is steeper than the slope 232. The voltage compensator 33 functions to maintain the average rate of current flow in the coil 14 substantially constant. As the rectified voltage on line 42 increases, the rate at which the capacitor 80 charges also increases as indicated by the current ramps 234 shown dashed in FIG. 2B. Within the voltage compensator 33, the steeper ramp 234 reaches a magnitude equal to the reference voltage magnitude 230 prior to another leading edge of a pulse 220. When the capacitor voltage exceeds the reference voltage 230, the comparator 74 switches state and goes low as shown at 236 in FIG. 2D. That low state 236 switches the state of AND gate 39 and causes the switch driver 68 to open the power switch 48 while the switch 50 remains closed, thereby disconnecting terminal 34 from the positive supply line 42. The rate of current increase in the coil 14 goes to substantially zero, and the coil current coasts and maintains a substantially constant or slightly lesser value, as shown by the dashed lines 238 in FIG. 2E.

Upon an occurrence of a subsequent pulse 220, the capacitor 80 discharges and the comparator 74 again changes state, thereby opening the AND gate 39 and causing the switch driver 68 to close the power switch 48. Thus, for rectified voltages having a value greater than the minimum rectified voltage value, the voltage compensator 33 is effective to produce a pulse width modulated output from comparator 74 that, via AND gate 39, limits the operation of the first power switch 48 in inverse proportion to the rectified voltage over the minimum rectified voltage. The result is to create a current in the coil 14 represented by the dashed lines 235 and 238 of FIG. 2E, which has a substantially constant slew rate and on average is substantially equal to a current slew rate represented by the line 232.

The net result is a leading edge of a peak current pulse with a saw-tooth form as shown at 212 in FIG. 3A, which provides an initial rate of current flow in the coil 14 that is, on average, substantially similar to the rate of current flow provided by slope 208 produced by a desired line voltage value. Further, at the chosen, minimum rectified voltage, the voltage compensator 33 provides a continuous output that does not affect the rate of current flow into the coil 14. However, for rectified voltages greater than the minimum rectified voltage, the voltage compensator 33 provides a pulse width modulated output which has a duty cycle that decreases with increases in the rectified voltage. If the R-C circuit time constant is chosen to be sufficiently larger than the period T, so that the voltage compensator 33 is operating in a linear portion of the capacitor charging curve, the duty cycle from the voltage compensator 33 will change substantially linearly with changes in the rectified voltage on line 42.

When the current in the coil 14 exceeds the peak current setpoint, the modulator 64 commands the switch driver 66 to open the switch 48. The coil current value then falls until the error signal from the summation node 62 falls below the peak current setpoint, and the modulator 64 again turns on switch 48. The hysteresis modulator 64 modulates the switch 48 in this manner for a duration T_{PK} as shown at 202 in FIG. 3B. The larger peak current 202 is effective to quickly operate the solenoid 23 and open the dispensing gun 15.

After opening the dispensing gun 15, the gun driver 10 supplies a current necessary to hold the dispensing gun 15 open by overcoming the opposing force of the return spring 25. The waveform generator 16 initiates State 2 at the end of the pull-in time T_{PK} by changing its output from the peak current setpoint I_{PK} to a hold current setpoint I_{H}. The reduced current setpoint causes the switch 48 to open while the switch 50 remains closed, thereby disconnecting the terminal 34 from the positive supply line 42. The current in the solenoid coil 14 then discharges a through discharge circuit including the coil 14, the current sensor 20 and diode 56, and the coil current dissipates at a rate determined by the resistance in the discharge circuit. Thus, current in the solenoid coil 14 drops or coasts down to the desired hold current setpoint I_{H} as shown by the current waveform 204. Thereafter, the hysteresis modulator 64 again modulates the operation of the switch 48 to maintain the current in the coil 14 at the hold current setpoint I_{H}.

At the end of the dispensing cycle, State 3 is initiated by an end, or a falling trailing edge, of the gun ON/OFF signal from the system control 12, which causes the current setpoint be set at, or close to, zero. If the line voltage remains at its desired value, current in the coil 14 will discharge at a rate represented by the slope 214 in FIG. 3B. In the absence of the voltage compensator 33, changes in line voltage and hence, the rectified voltage on line 42, will also produce changes in the rate at which current dissipates from the coil 14 at the end of a dispensing cycle. Such changes in the current slew rate also change the speed and actuation time at which the dispensing valve is closed and, in turn, result in an undesirable dispensing of fluid. However, the voltage compensator 33 can also be used to modulate coil current when the dispensing gun 15 is being turned off, so that the rate of current reduction in the solenoid coil 14 is substantially independent of changes in the rectified voltage.

When a trailing edge of the gun ON/OFF signal is received from the system control 12, State 3 is initiated; and the first switch 48 is opened. At the minimum rectified voltage, the output of the line compensator 33 remains high as shown by outputs 228 in FIG. 2C. That output is applied to an inverted input of the OR gate 43 and with a low input from the gun ON/OFF signal, the second switch 50 is also opened. The coil 14 is clamped to the supply 19 via diodes 54, 56 and current is quickly dissipated in accordance at a rate indicated by the slope 214 of FIG. 3B. However, if rectified voltage is greater than the minimum rectified voltage, the voltage compensator 33 operates as described earlier; and provides a pulse width modulated output having a duty cycle that is inversely proportional to the rectified voltage. When the output from the voltage compensator 33 goes low as shown at 236 in FIG. 2D, a high output from the OR gate 43 causes the switch driver 69 to close the second switch 50. Current in the coil coasts and discharges more slowly as indicated by slopes 240 in FIG. 3A. However, when the voltage compensator 33 goes high as shown at 228 of FIG. 2C, the output from the OR gate 43 causes the second switch 50 to open and clamp the coil 14 to the supply 19. Current in the coil 14 dissipates quickly to the supply 19 as shown by the slopes 242 of FIG. 3A. By modulating the operation of the second switch 50, the slopes 240, 242 result in an average current slew rate that, on average, is substantially similar to the desired slope 214. Thus, closing speed and actuation time of the dispensing valve 15 are maintained substantially constant and independent of variations in the output voltage from the power supply 19.

In use, upon the dispensing gun 15 being commanded to turn on and turn off, the voltage compensator 33 is effective to maintain a substantially constant rate of current flow in the coil 14 independent of changes in the nominal line voltage and/or changes in the rectified voltage on line 42. The voltage compensator 33 is effective to continuously compensate for ripple in the rectified voltage on line 42 as well as any expected or predictable changes in the line voltage greater than the chosen, minimum rectified voltage. Thus, with the voltage compensator 33, the gun driver 10 provides a stable, consistent and high quality fluid dispensing process independent of most line voltage variations. Further, the gun driver 10 is less expensive, operates more efficiently with less power loss and requires less cooling than a gun driver having a regulated power supply. Thus, the gun driver 10 is especially advantageous in those applications where better performance is required at a lesser cost.

While the present invention has been illustrated by a description of various embodiments and while these embodiments have been described in considerable detail, it is not intended to restrict or in any way limit the scope of the appended claims to such detail. Additional advantages and modifications within the spirit and scope of the invention will readily appear to those skilled in the art. For example, the current sensor 20, summing node 62, hysteresis modulator 64 and logic gates 39, 43 are only an exemplary embodiment of a power switch control. In other applications, the power switch control may have other circuit components; but in general, the power switch control provides a pulse width modulation of the switches 48, 50 to generate a coil current corresponding to the output of the waveform generator 16.

Further, FIG. 1 is only one example of how the present invention may be implemented, and other circuit architectures may be used to implement the principles of the present invention. For example, the gun driver 10 of FIG. 1 utilizes two switches 48, 50 to dissipate current from the coil 14. Such a switch configuration is commonly known as an asymmetric H-bridge driver configuration. As will be appreciated, other gun driver configurations may implement the principles of the claimed invention. For example, a full H-bridge configuration uses four switches to provide a reverse current flow through the coil in order to more quickly close the dispensing valve. As will be appreciated by those skilled in the art, the claimed invention can be readily applied to drivers having a full H-bridge configuration, thereby making operational speed and actuation time of the dispensing valve independent of changes in the magnitude of the output voltage from an unregulated power supply.

In addition, the waveforms illustrated in FIGS. 2 and 3 are for purposes of discussion; and the real waveform consists of exponential functions that transition the current between levels. The real time wave shapes can look different from the idealized waveforms of FIGS. 2 and 3, depending on many factors such as I_{PK}, I_{H}, T_{PK}, T_{ON}, L_{coil 14}, R_{coil 14}, etc. The T_{ON} is related to the adhesive pattern required for a particular product. The inductance and resistance of the coil are a function of the gun itself, and the I_{PK} is normally bounded by various considerations of the fluid dispenser 15 such as magnetic saturation, thermal considerations or force requirements. Further, initial values of magnitudes of the peak and hold currents are based on the coil specifications. However, the peak current magnitude I_{PK}, the magnitude of the hold current I_{H} and the duration of the peak current T_{PK} are often adjustable by the user. The user may adjust the current waveform and the dispensing line rate in order to tune the dispensing operation to its peak performance.

As will be further appreciated, depending on the design and application parameters, the invention may be implemented using analog, digital or a combination of digital and analog circuit components in any configuration that automatically holds the operational speed and actuation time of the dispensing valve constant and independent of variations in the output voltage of the unregulated power supply 19.

Therefore, the invention in its broadest aspects is not limited to the specific detail shown and described. Consequently, departures may be made from the details described herein without departing from the spirit and scope of the claims which follow.

What is claimed is:

1. A driver circuit for an electrically operated fluid dispenser dispensing a fluid: onto a substrate, the fluid dispenser having a dispensing valve and a solenoid coil operative to cause the dispensing valve to move between open and closed positions, the driver circuit comprising:
a power source providing an unregulated rectified voltage;
a power switching circuit connected to the power source and the solenoid coil and operable to supply current to the solenoid coil;
a waveform generator producing a stepped waveform comprising an initial peak current portion followed by a lesser hold current portion, the initial peak current portion having an initial rate of current flow represented by a slope of a leading edge of the initial peak current portion;
a power switch control operating the power switching circuit in response to at least the stepped waveform; and
a voltage compensator connected to the power source and the power switch control and comprising
a pulse generator providing a plurality of pulses over successive periods,
an integrator having an input responsive to the unregulated rectified voltage and operable to provide a plurality of independent integrated voltage values over the successive periods, the integrator being reset in response to each of the pulses, and
a comparator for comparing each of the independent integrated voltage values with a reference voltage and providing a comparator output to the power switch control in response to each of the independent integrated voltage values exceeding the reference voltage, the comparator output controlling an operation of the power switch control to maintain the leading edge of the initial peak current portion substantially constant and independent of variations in the unregulated rectified voltage.

2. The driver circuit of claim 1 wherein the integrator comprises:
a voltage controlled current source; and
a capacitor being chargeable by the current source.

3. The driver circuit of claim 1 wherein the voltage controlled current source comprises a resistor connected to the capacitor in a series circuit.

4. The driver circuit of claim 4 wherein a time constant of the series circuit is substantially greater than a time duration of each of the successive periods.

5. The driver circuit of claim 5 wherein a time constant of the series circuit is more than one order of magnitude greater than a time duration of each of the successive periods.

6. The driver circuit of claim 3 wherein the voltage compensator further comprises a switch connected to the pulse generator and the capacitor, the switch closing in response to each of the plurality of pulses and discharging the capacitor.

7. The driver circuit of claim 1 wherein the power switch control comprises:
a current sensor providing a current feedback signal representing current flow in the solenoid coil;
a summing node responsive to the stepped waveform from the waveform generator and the current feedback signal;
a hysteresis modulator connected to an output of the summing node; and
a logic gate having a first input connected to the hysteresis modulator, a second input connected to the comparator output and a gate output connected to the power switching circuit.

8. A driver circuit for an electrically operated fluid dispenser dispensing a fluid onto a substrate, the fluid dispenser having a dispensing valve movable between open and closed positions and a solenoid coil operative to cause the dispensing valve to move between the open and closed positions, the driver circuit comprising:
a power switching circuit operably connected to the solenoid coil;
a power source providing an unregulated rectified voltage to the power switching circuit;
a waveform generator producing a stepped waveform comprising an initial peak current portion followed by a lesser hold current portion, the initial peak current portion having a rate of current flow represented by a slope of a leading edge of the initial peak current portion;
a current sensor providing a current feedback signal representing current flow in the solenoid coil;
a summing node responsive to the stepped waveform from the waveform generator and the current feedback signal;
a hysteresis modulator connected to an output of the summing node;
a logic gate having an input connected to the hysteresis modulator and an output connected to the power switching circuit, the power switching circuit being operated by an output signal from the hysteresis modulator; and
a voltage compensator comprising
a pulse generator providing a plurality of pulses over successive periods,
a voltage controlled current source connected to the unregulated rectified voltage,
a capacitor being discharged by each of the pulses and being chargeable by the current source between successive pulses, the capacitor providing an integrated voltage value over each successive period, and
a comparator for comparing each integrated voltage value with a reference voltage and providing a comparator output to the power switch control in response to each integrated voltage value exceeding the reference voltage, the comparator output controlling an operation of the power switching circuit to maintain the leading edge of the initial peak current portion substantially constant and independent of variations in the unregulated rectified voltage.

9. A method of operating an electrically operated fluid dispenser dispensing a fluid onto a substrate, the fluid dispenser having a dispensing valve and a solenoid coil operative to cause the dispensing valve to move between open and closed positions, the method comprising:
providing an unregulated rectified voltage;
producing a stepped waveform comprising an initial peak current portion followed by a lesser hold current portion, the initial peak current portion having an initial rate of current flow represented by a slope of a leading edge of the initial peak current portion;
operating a power switching circuit in response to at least the stepped waveform to supply current to the solenoid coil;
integrating the unregulated rectified voltage over successive periods of time to provide an integrated voltage value;
comparing the integrated voltage value to a reference voltage; and
during each successive period of time, operating the power switching circuit to terminate the supply of current to the solenoid coil in response to the integrated voltage value being greater than the reference voltage to maintain the leading edge of the initial peak current portion substantially constant and independent of variations in the unregulated rectified voltage.

10. The method of claim 9 wherein integrating the unregulated rectified voltage further comprises charging a capacitor with a voltage controlled current source connected to the unregulated rectified voltage.

11. The method of claim 10 further comprises discharging the capacitor with each successive period of time.

12. The method of claim 11 further comprising generating a plurality of pulses defining the successive periods of time.

13. The method of claim 12 further comprising discharging the capacitor with each of the plurality of pulses.

14. The method of claim 9 further comprising limiting an operation of the power switching circuit in response to the integrated voltage value being greater than the reference voltage.

15. The method of claim 9 further comprising pulse width modulating an operation of the power switching circuit in response to the integrated voltage value being greater than the reference voltage.
